(19) United States
(12) Patent Application Publication
(10) Pub. No.: US 2006/0136269 A1
(43) Pub. Date: Jun. 22, 2006

(54) Method and process for preparing and analyzing medical legal cases

(76) Inventor: Nancy E. Fraser, Santa Monica, CA (US)

Correspondence Address: GREENBERG TRAURIG LLP, 2450 COLORADO AVENUE, SUITE 400E, SANTA MONICA, CA, 90404, US

(21) Appl. No.: 11/291,206

(22) Filed: Nov. 29, 2005

Related U.S. Application Data
(60) Provisional application No. 60/631,944, filed on Nov. 29, 2004.

(51) Int. Cl. G06F 19/00; G06Q 40/00; G06F 17/30; G06F 17/21

(52) U.S. Cl. 705/3; 707/1; 715/500; 705/4

(57) ABSTRACT

The present disclosure describes a method and system which extracts data from medical informational sources in order to organize, analyze, and summarize the information into document form so that it may be used with ease by lawyers in preparing medical legal cases. In one aspect, such a document is a patient chronology. In another aspect, such a document is a plan for a patient's needs for future care.

### RELATED APPLICATIONS

This application claims the benefit of the prior filing date of U.S. provisional patent application No. 60/631,944, filed Nov. 29, 2004, which is hereby incorporated by reference in its entirety.

### BRIEF DESCRIPTION

The present disclosure relates generally to a method and process for organizing, analyzing, and summarizing various medical informational data into document form so that it may be used with ease by lawyers and for consultations in preparing and evaluating medical legal cases.

### BACKGROUND OF THE DISCLOSURE

Legal cases involving medical claims can be very complex and time consuming. This complexity is due to many factors such as a large amount of medical records, bills, and medical jargon. The task of assimilating medical records in preparation for litigation is further compounded for persons such as attorneys who do not have the medical background and education to quickly understand intricate medical issues. Thus, organizing and understanding voluminous medical information can be time consuming, expensive, and incomplete.

Consequently, there remains a need for a process and method that is able to efficiently and cost-effectively organize and analyze medical information, and produce documents into forms which are easily used by non-medical persons such as lawyers.

### BRIEF DESCRIPTION OF THE DRAWINGS

The following drawing figures, which form a part of this application, are illustrative of embodiments of the present invention and are not meant to limit the scope of the invention in any manner, which scope shall be based on the claims appended hereto.

FIG. 1 is an exemplary patient chronology chart according to one exemplary embodiment; and

FIG. 2 is an exemplary a document determining the plan for a patient's needs for future care according to one exemplary embodiment.

### SUMMARY OF THE DISCLOSURE

The present disclosure allows for a method and process to efficiently extract analyze, organize, and convert into a professional/technical document form, all pertinent facts from various medical informational sources in order to prepare for a medical legal case.

Such medical informational sources may include medical charts, specific medical history, medical bills, anthropomorphic data, laboratory reports, recent medical developments, various medical statistics, statistical analysis in order to find trends that apply to entire specific class of individuals, statements from medical personnel, treating personnel, and other hospital records. Furthermore, depositions, testimonies, affidavits, statements from witnesses, police officers, and victims may be used as informational sources as well.

The object of the disclosure is to methodically organize and digest all relevant medical information into document form which can be easily used in litigation. Such professional/technical documents created can be in the form of charts, report, summary, maps, pictures, graphs, summaries, spreadsheets, technical or legal arguments, analysis, legal action plans, and predictions or projections.

In one embodiment, a registered nurse is employed to extract all pertinent medical information, and to organize/analyze such information. The use of a professional and experienced nurse to organize and analyze information provides a valuable insight to the end user. Also, the document created may be heavily cross-referenced in order to provide ease of reading and use to the reader. The cross-reference may refer to tabs, chapters, sections, pages, or to any denotation system which may be useful to the end user.

Additionally, the documents can be created by programmable computer software program, wherein the disclosed method is implemented by the use of specific, programmable data structures, computer software, and relational databases. The data structure can be programmed to contain at least one field. The fields may be relationally linked and the databases may be relationally structured. The program has the ability to interface with a user so that the user may input, manage, manipulate, organize, analyze and compile various data into various document forms.

Another object of the present disclosure is the ability to determine which documents, records, files, information sources are missing from a file or which documents are lacking and which are necessary to complete the analysis. In one embodiment, the program or method has the ability to survey the list of documents present against a specified list of suggested, required or preferred documents and has the capability to provide an analysis and output of which documents are not present.

In one embodiment, a document determining the usual and customary level of medical costs and bills is created. This embodiment utilizes medical bills in order to establish the usual and customary medical costs for charges for treatments, medications, office visits. For example, this embodiment determines the usual and customary medical costs based upon multiple variables such as specific geographic area and time period. Of course, any variable useful in determining the usual and customary level of medical costs is contemplated in creating this document.

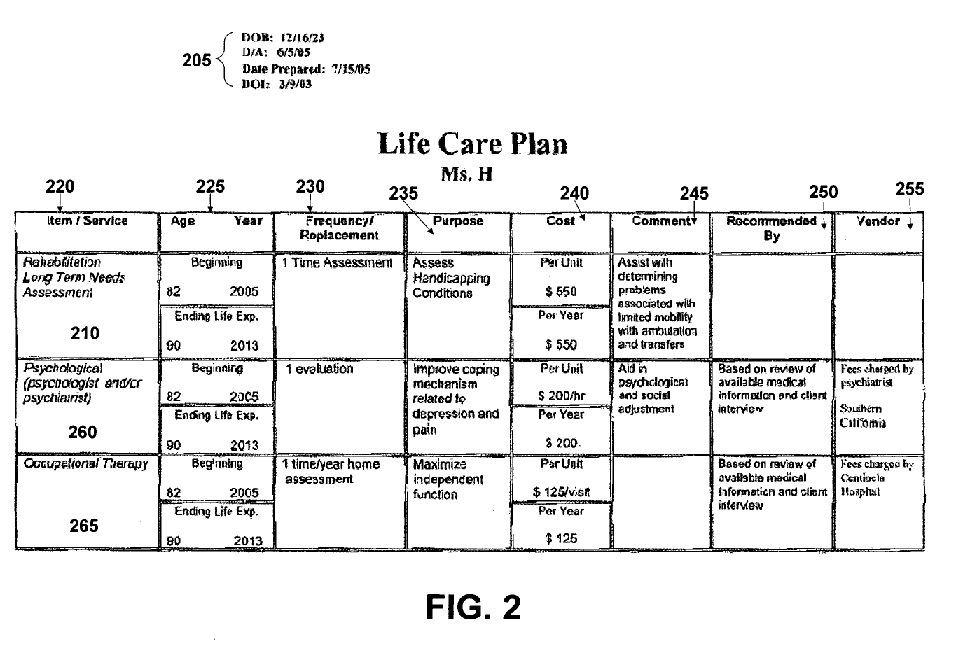

In another embodiment, a document determining a plan for a patient's needs for future care is created. For example, this embodiment utilizes medical bills, records, and other databases to establish the costs of future medical services, equipment, supplies, and/or treatments and the costs required to maintain a quality of life for a particular person. For example, such services, equipment, supplies, and/or treatments may comprise physical therapy, rehabilitation, occupational therapy, recreational therapy, dietician consultant, counseling, case manager, conservator costs, routine checkups and lab work, all medical costs, wheelchair and associated costs, etc. An exemplary document determining a plan for a patient's needs for future care is depicted in FIG. 2. As can be seen in FIG. 2, the plan for a patient's needs for future care document comprises a chart listing each item, service, or treatment by rows 210, 260, 265 and a heading 205 listing relevant patient and chart information such as the patient's date of birth, the date of the accident or injury, and/or the date the document was prepare. Further each item, service, or treatment is organized into columns such as the patient's life expectancy 225 listed by age and by year, the frequency of treatment and/or replacement 230, the purpose of the treatment or service 235, the cost by year and by unit of service 240, any relevant comments 245, the identity of the individual recommending the treatment or service 250, and the vendor associated with the service 255. For example, the second item or service 260 is psychological treatment for the purpose 235 to “improve coping mechanism related to depression and pain.” As depicted in FIG. 2, the psychological treatment for the patient's life expectancy 225 is until the year 2013, as the patient is expected to live until the age of 90. It is predicted that it will be a one time treatment 230 and cost $200.00 per unit, per hour and accordingly $200.00 per year. Additionally, the document provides that the treatment was based on a review of available media information and client interview 250 and that the vendor for the service/treatment is “Southern California” 255. Any variable useful in determining a plan for a patient's needs for future care is contemplated in creating this document.

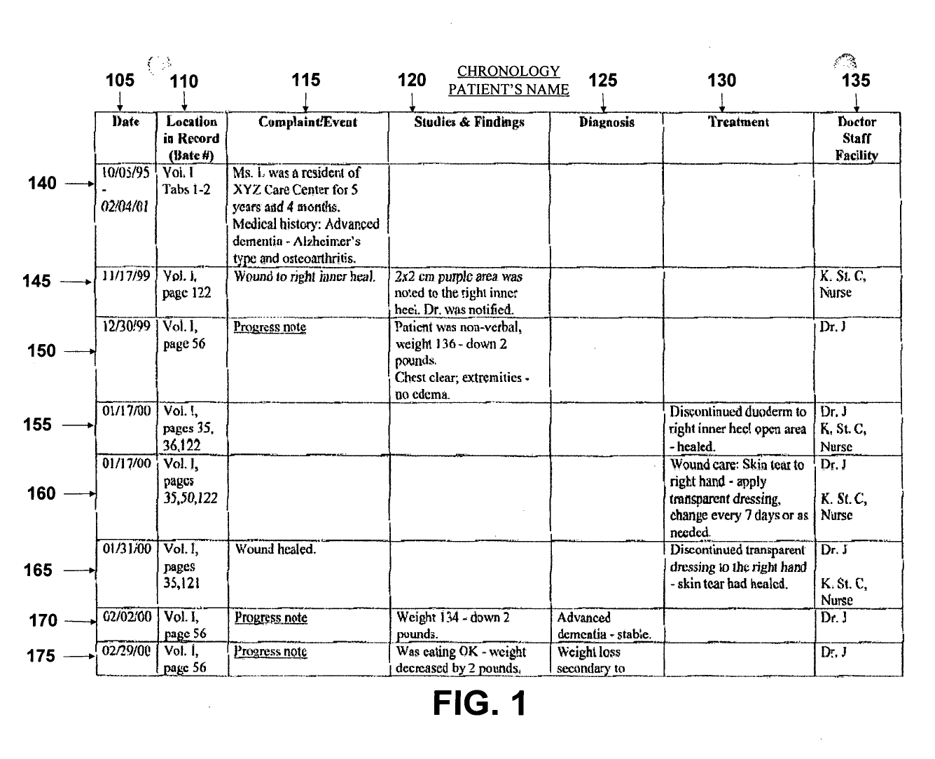

In a further embodiment, a chart determining a patient chronology of medical events is created. For example, this embodiment provides a sequential listing and organization of all events related to the medical legal case including entries such as the date of the event, a reference notation to the original document, a cross-referenced bate number, a summary of the event, the chief complaint of the medical event by the patient, the studies and findings of the medical personnel during the event, diagnosis, treatment, and the medical personnel's name and position. An exemplary patient chronology document is depicted in FIG. 1. As can be seen in FIG. 1, the exemplary patient chronology chart comprises a table in which the each chronological event is listed in a separate row 140-175. Further, each row is organized into columns 105-135. In particular, each chronological event is organized into a date 105 column that lists the dates associated with the event, a reference 110 that lists internal cross-references to the event, a descriptive column 115 that includes a brief description about that the event, a column listing the studies and findings 120 associated with the event, any applicable diagnoses 125 associated with the event, a treatment column 130 that lists any associated treatment, and the applicable medical doctor or nurse 135 associated with the event. For example, for event 145, as can be seen in the patient chronology chart, the event concerns a wound to the patient right inner ear that occurred on Nov. 17, 1999, and has an internal cross reference. Further, the event has an associated studies and findings that the wound had a particular size and description and that the associated medical doctor was a Dr. J. Of course, any variable useful in determining the patient chronology of medical events is contemplated in creating this document.

In another embodiment, a document determining the merits of a particular legal case is created. For example, this embodiment provides a case screening analysis where the absence or presence of legal element in a medical case is determined by analyzing the various medical informational sources. The case screening analysis could include topical areas such as a brief introduction of the case, standard of care deviations such what the medical personnel failed to do, a summary of the relevant facts of the case, a discussion of potential flagged issues, and a recommendation section where a list of potential experts are suggested, and further discovery of information is identified. Any variable useful in determining the merits of a particular legal case is contemplated in creating this document.

While the above description contains many specifics, these should not be construed as limitations on the scope of the disclosure, but rather as an exemplification of one embodiments thereof. Furthermore, the method and system described above contemplate many applications of the present disclosure. The method and system contemplates generating, by various technological means, a document to be used with ease by lawyers and for consultations in preparing and evaluating medical legal cases.

In closing, it is noted that specific illustrative embodiments of the invention have been disclosed hereinabove. However, it is to be understood that the invention is not limited to these specific embodiments. Accordingly, the invention is not limited to the precise embodiments described in detail hereinabove. With respect to the claims, it is applicant's intention that the claims not be interpreted in accordance with the sixth paragraph of 35 U.S.C. §112 unless the term “means” is used followed by a functional statement. Further, with respect to the claims, it should be understood that any of the claims described below may be combined for the purposes of the invention.

I claim:

1. A method for generating a technical document comprising:
extracting data from at least one medical informational source; analyzing the data; and
organizing the data to create said technical document.

2. The method of claim 1 wherein said medical informational source comprises a medical chart.

3. The method of claim 1 wherein said medical informational source comprises a specific individual's medical history.

4. The method of claim 1 wherein said medical informational source comprises a set of medical bills associated with a specific individual.

5. The method of claim 1 wherein said medical informational source comprises anthropomorphic data.

6. The method of claim 1 wherein said medical informational source comprises laboratory reports.

7. The method of claim 1 wherein said medical informational source comprises a set of medical statistics.

8. The method of claim 1 wherein said medical informational source comprises information derived from medical personnel.

9. The method of claim 8 wherein said information is derived from an affidavit.

10. The method of claim 8 wherein said information is derived from a testimony.

11. The method of claim 8 wherein said information is derived from a deposition transcript.

12. The method of claim 1 wherein said medical informational source comprises information derived from law enforcement personnel.

13. The method of claim 12 wherein said information is derived from an affidavit.

14. The method of claim 12 wherein said information is derived from a testimony

15. The method of claim 12 wherein said information is derived from a deposition transcript.

16. The method of claim 1 wherein said medical informational source comprises information derived from a witness.

17. The method of claim 16 wherein said information is derived from an affidavit.

18. The method of claim 16 wherein said information is derived from a testimony.

19. The method of claim 16 wherein said information is derived from a deposition transcript.

20. The method of claim 1 wherein said medical informational source comprises information derived from a patient.

21. The method of claim 20 wherein said information is derived from an affidavit.

22. The method of claim 20 wherein said information is derived from a testimony.

23. The method of claim 20 wherein said information is derived from a deposition transcript.

24. The method of claim 1, wherein said technical document comprises a patient chronology chart.

25. The method of claim 24 wherein said patient chronology chart comprises:
a date of a medical event; and
a reference notation associated with a first document.

26. The method of claim 25 wherein said first document is an original medical document.

27. The method of claim 26 wherein said original medical document comprises a medical chart.

28. The method of claim 26 wherein said original document comprises a specific individual's medical history.

29. The method of claim 26 wherein said original document comprises a set of medical bills associated with a specific individual.

30. The method of claim 25 wherein said patient chronology chart further comprises a chief complaint of the medical event.

31. The method of claim 25 wherein said patient chronology chart further comprises a medical personnel's studies and findings.

32. The method of claim 25 wherein said patient chronology chart further comprises a diagnosis of the medical event.

33. The method of claim 25 wherein said patient chronology chart further comprises a treatment associated with the medical event.

34. The method of claim 25 wherein said patient chronology chart further comprises an identity of medical personnel associated with the medical event.

35. A method for generating a technical document comprising:
extracting data from at least one medical informational source;
analyzing the data; and
organizing the data to create said technical document, wherein said technical document comprises a plan for a patient's needs for future care.

36. A method for generating a technical document comprising:
extracting data from at least one medical informational source;
analyzing the data; and
organizing the data to create said technical document, wherein said technical document comprises the usual and customary level of medical costs and bills.
